(19) United States
(12) Patent Application Publication
(10) Pub. No.: US 2013/0094682 A1
(43) Pub. Date: Apr. 18, 2013

(54) AUGMENTED REALITY SOUND NOTIFICATION SYSTEM

(71) Applicants: HOU-HSIEN LEE, Tu-Cheng (TW); CHANG-JUNG LEE, Tu-Cheng (TW); CHIH-PING LO, Tu-Cheng (TW)

(72) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 13/448,421

(22) Filed: Apr. 17, 2012

(30) Foreign Application Priority Data
Oct. 14, 2011 (TW) 100137403

(51) Int. Cl. H04R 5/02; G09G 5/00

(52) U.S. Cl. 381/306

(57) ABSTRACT

A method for forming an augmented reality, which includes a surrounding environment and an augmented image. The method comprises: receiving ambient noise by an microphone array; determining whether an event is happening by analyzing the ambient noise. Generating a sound information related to the event from the ambient noise. Then determining a direction of the event relative to the user, and a sound volume of the event; generating content information of the event based on the sound information. Generating the augmented image representing the direction, sound volume, and content information of the event; and showing the surrounding environment and the augmented image on a display unit.

### BACKGROUND

1. Technical Field

The present disclosure relates to a sound notification system, and particularly, to a sound notification system using augmented reality.

2. Description of Related Art

Hearing-impaired people lose the ability to sense sounds around them, and may only use vision to be aware of emergencies. Therefore, while normal people can hear surrounding sound like car honking, it may be dangerous for hearing-impaired people if events happened beyond their vision.

Therefore, what is needed is a sound notification system that overcomes the above mentioned situation.

### BRIEF DESCRIPTION OF THE DRAWINGS

The components in the drawings are not necessarily drawn to scale, the emphasis instead being placed upon clearly illustrating the principles of a sound notification system. Moreover, in the drawings, like reference numerals designate corresponding parts throughout the several views.

FIG. 1 is a block diagram of a sound notification system in accordance with an exemplary embodiment.

FIG. 2 is an isometric view of a sound notification system in accordance with an exemplary embodiment.

FIG. 3 is a schematic view showing an arrangement of a microphone array of the sound notification system of FIG. 1.

FIG. 4 shows an environmental context in which the sound notification system of FIG. 1 is used.

FIG. 5 shows an augmented reality formed by the sound notification system of FIG. 1.

FIG. 6 is a flowchart of a method implemented by the sound notification system of FIG. 1, in accordance with an exemplary embodiment.

### DETAILED DESCRIPTION

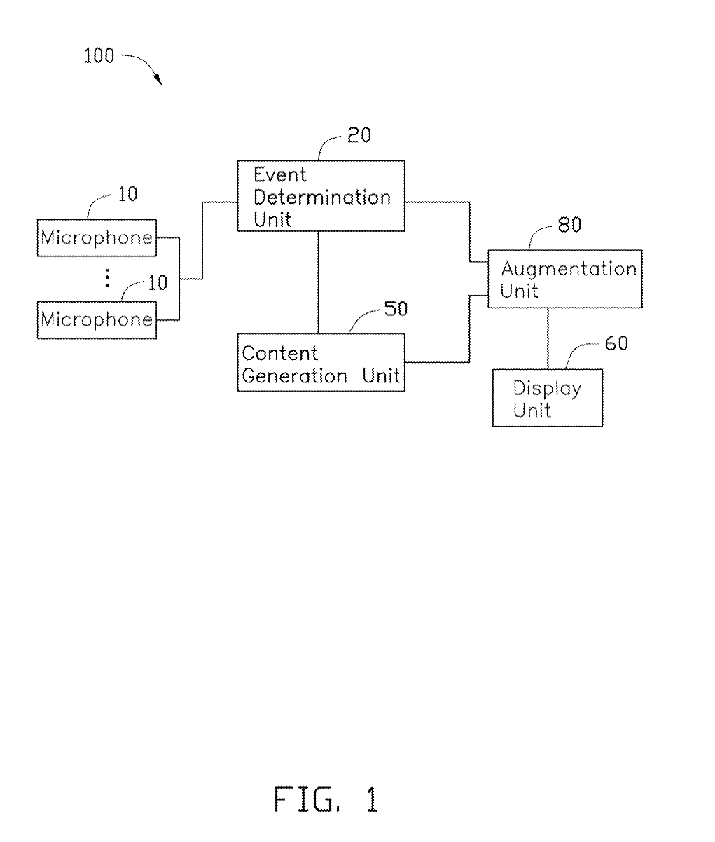

FIG. 1, is a sound notification system 100 including a number of microphones 10, an event determination unit 20, a content generation unit 50, a display unit 60, and an augmentation unit 80.

The microphones 10 make up a microphone array receiving ambient noises. The event determination unit 20 determines whether an event is happening in the surrounding environment based on the ambient noise received by the microphone array, and generates sound information, related to the event, from the ambient noise. The event determination unit 20 further determines the sound volume of the event and which direction the event happened relative to a user. The event determination unit 20 determines whether the sound volume of the event is louder than a predetermined threshold to eliminate background noises. In the present embodiment, the predetermined threshold is a warning threshold. The content generation unit 50 generates content information from the sound information related to the event. The augmentation unit 80 receives the direction, the sound volume, and the content information of the event, and generates augmented image representing the direction, the sound volume, and the content information of the event if the sound volume of the event is louder than the warning threshold. The display unit 60 shows an augmented reality, which is a combination of the surrounding environment the user can see and the augmented image generated by the augmentation unit 80.

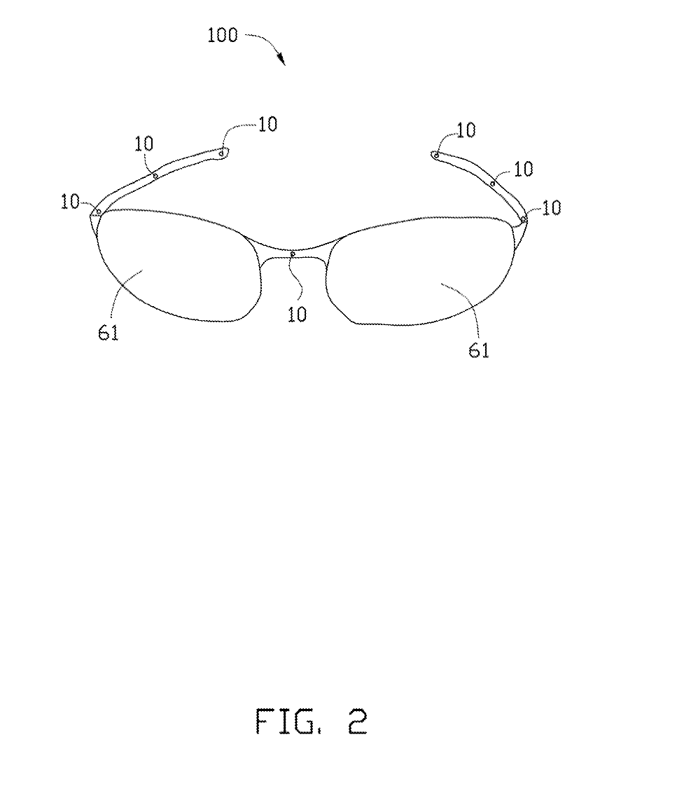

FIG. 2, shows in an embodiment, the sound notification system 100 is a pair of glasses 100. The event determination unit 20, the content generation unit 50, and the augmentation unit are embedded in a frame of the glasses 100. The display unit 60 is a pair of lens 61 of the glasses 100. Seven microphones 10 are exposed on different positions of the frame to form the microphone array.

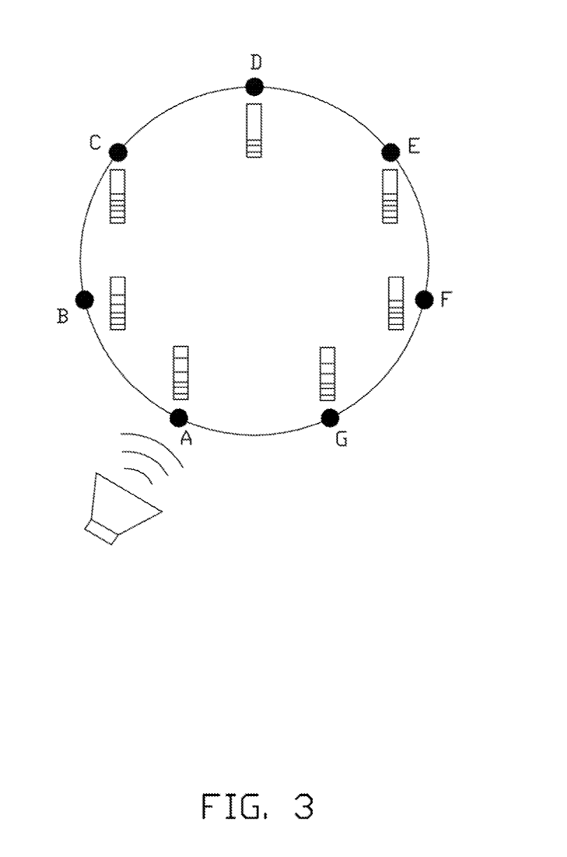

FIG. 3 shows the distribution of the microphones 10 of FIG. 2. Seven microphones 10 A-F are arranged approximately in a circle to receive the ambient noise. The event determination unit 20 determines whether an event is happening by analyzing the ambient sound received by the microphones 10 using Fourier transformation, and determines the direction and the sound volume of the event. Sound information related to the event can also be extracted from the ambient noise. In other embodiments, other direction determination methods, like beam forming method, for example, can also be applied to determine the direction of the event. The content generation unit 50 converts the sound information of the event into content information, like sentences or onomatopoeias using speech-to-text technique. For example, a speech from a person can be converted into a sentence, and a sound made from the environment can be converted into onomatopoeia. If the sound information cannot be recognized a symbol is used to show the sound signal. The augmentation unit 80 generates an augmented image representing the direction and the sound volume of the event for eliminating background noise, only when the sound volume of the event is louder than the warning threshold, and the augmented image is then shown on the display unit 60 to form an augmented reality.

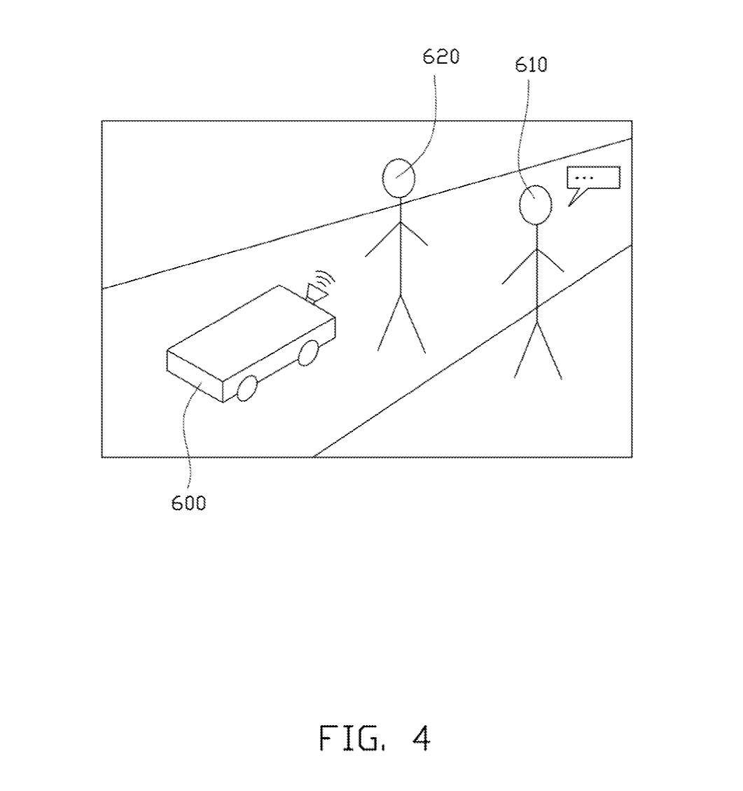

For further exemplifying the present disclosure, FIG. 4 shows a car 600 blowing its horn behind a hearing-impaired user 620, and a passerby 610 shouting at the user 620 that the car 600 is coming closer. The glasses 100 worn by the user 620 receive ambient noise. In the present embodiment, only the sound volumes of honking and the shouting are louder than the warning threshold, say 50 dB, and other events lower than 50 dB are determined to be background noise. When the honking and the shouting are louder than 50 dB, the augmented image is generated by the augmentation unit 80 and displayed on the lens 61 of the glasses 100 to form the augmented reality. If no sound of any event is louder than 50 dB, the glasses 100 act as a normal pair of glasses for seeing the surrounding environment.

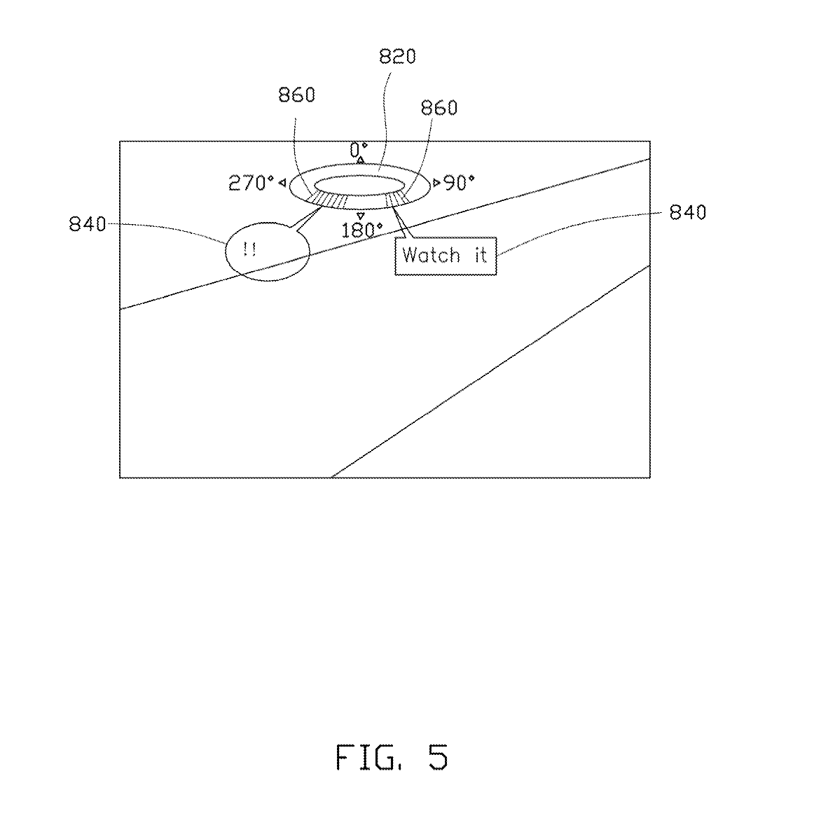

FIG. 5 is the augmented reality formed in the environmental context of FIG. 4. The augmented image generated by the augmentation unit 80 includes a compass object 820 for indicating the direction and the sound volume of the event, and two content objects 840 for indicating the honking and the shouting. In the present embodiment, the compass object 820 is a round or oval-shaped virtual compass 820, and the two content objects 840 are two dialogue boxes 840. Ahead of the user 620 is set to 0° angle in the virtual compass 820, and the direction of the honking from the car 600 is about 225° angle, indicated by the location of slashes 860 on the periphery of the virtual compass 820. The content of the dialog box 840 of the honking is two exclamation marks generated by the content generation unit 50 because the content generation unit 50 cannot recognize the sound of the honking The direction of the shouting from the passerby 610 is about 135° angle, and the slashes 840 of the shouting on the virtual compass 820 are less than that of the honking because the sound volume of the shouting is lower than the sound volume of the honking The content of the dialog box 840 of the shouting is “Watch it”, generated by the content generation unit 50 because the shouting can be recognized. The dialogue box 840 is arranged near the corresponding slashes 860. Alternatively, no slashes 860 are needed, the sound volume can be represented by the area of the dialogue box 840. The user 620 can adjust transparency of the augmented image, including the virtual compass 820, the slashes 860, and the dialogue box 840. In other embodiments, the display unit 60 can be a non-transparent display, and show the surrounding real world by taking images using a camera.

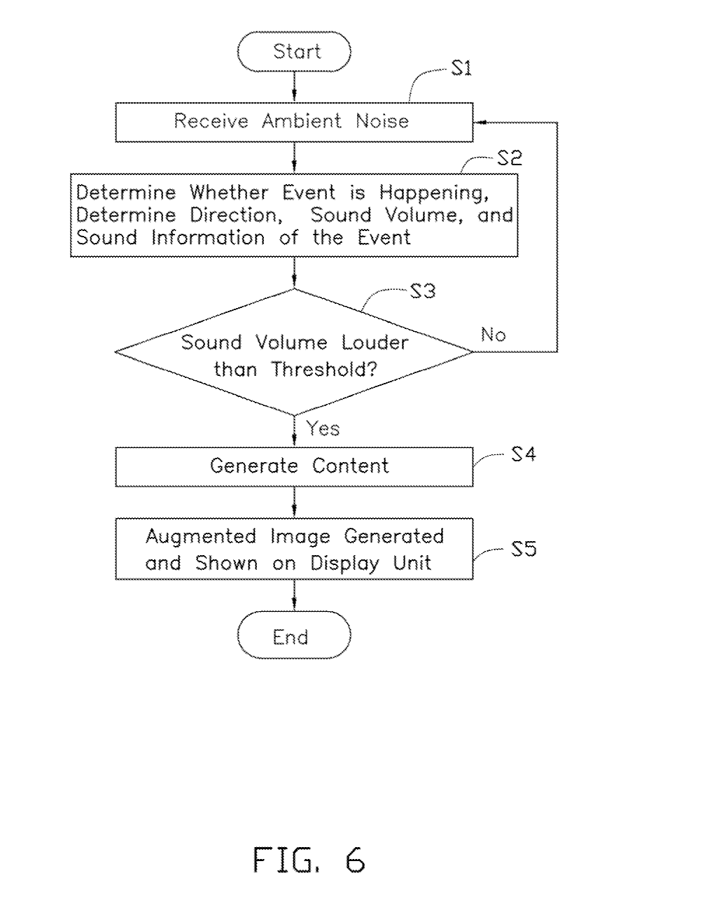

FIG. 6 shows a flowchart of a method implemented by the sound notification system 100. In step S1, the microphone array starts to receive the ambient noise. In step S2, an event is determined to be happening, the event determination unit 20 generates the sound information, the direction, and the sound volume of the event. In step S3, the event determination unit 20 determines whether the sound volume of the event is louder than the warning threshold; if the sound volume is louder than the warning threshold, it goes to step S4. In step S4, the content generation unit 50 generates the content information. In step S5, the augmented image is generated and is shown on the display unit 60 to form the augmented reality. In other embodiments, the direction and the content information can only be generated when the sound volume is determined to be louder than the warning threshold to save computing resources of the sound notification system 100.

Therefore, the sound notification system 100 can provide the hearing-impaired user with surround sound information in real time with the augmented reality.

Although the present disclosure has been specifically described on the basis of this exemplary embodiment, the disclosure is not to be construed as being limited thereto. Various changes or modifications may be made to the embodiment without departing from the scope and spirit of the disclosure.

What is claimed is:

1. A sound notification system, comprising:
a microphone array for receiving ambient noise;
an event determination unit for analyzing the ambient noise, and determining whether an event is happened based on the analysis of the ambient noise, generating a sound information corresponding to the event from the ambient noise, determining a sound volume of the event, and determining a direction of the event in relative to sound notification system;
a content generation unit for generating content information of the event by analyzing the sound information corresponding to the event;
an augmentation unit for generating an augmented image representing the direction, the sound volume, and the content information of the event; and
a display unit for showing surrounding real environment and the augmented image.

2. The sound notification system as claimed in claim 1, wherein the augmented image comprises a round or oval-shaped compass object; a region of the periphery of the compass object is highlighted, and the position of the highlighted region relative to the center of the compass object indicates the direction of the event in relative to the user; the augmented image further comprises a content object showing the content information of the event; the content object is arranged outside the compass object, and is arranged near the highlighted region of the periphery of the compass object.

3. The sound notification system as claimed in claim 2, wherein the highlighted region of the periphery of the compass object is highlighted with at least one slash; the number of the at least one slash indicates the sound volume of the event.

4. The sound notification system as claimed in claim 2, wherein the content object is a dialogue box showing the content information of the event.

5. The sound notification system as claimed in claim 2, wherein a size of the content object indicates the sound volume of the event.

6. The sound notification system as claimed in claim 1, wherein the microphone array is arranged on a frame of the glasses; the microphone array comprises a plurality of microphones; each of the plurality of microphones are arranged on different positions of the frame of the glasses.

7. The sound notification system as claimed in claim 1, wherein the content information is a sentence or at least one onomatopoeia corresponding to the event if the sound information corresponding to the event is recognized by the content generation unit.

8. The sound notification system as claimed in claim 1, wherein the content information is at least one symbol if the sound information corresponding to the event cannot be recognized by the content generation unit.

9. The sound notification system as claimed in claim 1, wherein the augmented image is generated when the sound volume corresponding to the event is louder than a predetermined threshold.

10. The sound notification system as claimed in claim 1, wherein the display unit is a transparent display for seeing the surrounding real environment, and the augmented image is displayed on the transparent display while not blocking the entire surrounding real environment.

11. The sound notification system as claimed in claim 1, wherein the display unit is an opaque display showing the surrounding real environment, and the augmented image is shown on the opaque display while not blocking the entire surrounding real environment.

12. The sound notification system as claimed in claim 1, wherein a transparency of the augmented image shown on the display can be adjusted.

13. A method for forming an augmented reality comprising a surrounding real environment and an augmented image, comprising:
receiving ambient noise by an microphone array;
determining whether an event is happened by analyzing the ambient noise;
generating a sound information related to the event from the ambient noise if an event is happened;
determining a direction of the event in relative to the user, and a sound volume of the event;
generating content information of the event based on the sound information;
generating the augmented image representing the direction, sound volume, and content information of the event; and
showing the surrounding real environment and the augmented image on a display unit.

14. The method as claimed in claim 14, wherein the augmented image comprises a round or oval-shaped compass object; a region of the periphery of the compass object is highlighted, and the position of the highlighted region relative to the center of the compass object indicates the direction of the event in relative to the user; the augmented image further comprises a content object showing the content information of the event;
the content object is arranged outside the compass object, and is arranged near the highlighted region of the periphery of the compass object.

15. The method as claimed in claim 15, wherein the highlighted region of the periphery of the compass object is highlighted with at least one slash; the number of the at least one slash indicates the sound volume of the event.

16. The method as claimed in claim 15, wherein the content object is a dialogue box showing the content information of the event.

17. The method as claimed in claim 15, wherein a size of the content object indicates the sound volume of the event.

18. The method as claimed in claim 15, wherein the augmented image is generated when the sound volume corresponding to the event is louder than a predetermined threshold.

19. The method as claimed in claim 15, wherein the content information is a sentence or at least one onomatopoeia corresponding to the event if the sound information corresponding to the event is recognized by the content generation unit.

20. The method as claimed in claim 15, wherein the content information is at least one symbol if the sound information corresponding to the event cannot be recognized by the content generation unit.
